(19) United States
(12) Patent Application Publication
(10) Pub. No.: US 2004/0148325 A1
(43) Pub. Date: Jul. 29, 2004

(54) Information processing means

(76) Inventors: Takashi Endo, Musashimurayama (JP); Masahiro Kaminaga, Sakado (JP); Takashi Watanabe, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/608,209

(22) Filed: Jun. 30, 2003

(30) Foreign Application Priority Data
Jan. 23, 2003 (JP) 2003-014136

(51) Int. Cl. G06F 7/00

(52) U.S. Cl. 708/492

(57) ABSTRACT

As fast algorithm for RSA cryptosystem, a calculation method employing the Chinese Remainder Theorem is widely used today. However, modular calculation modulo P (P: secret prime) has to be carried out in the first step of the calculation, and the modular calculation x mod P, explicitly using the secret prime P, has been used as the target of attack from long ago. To resolve the problem, there is provided a calculation method, in which x mod P is calculated not directly, but x*(2\hat{ }n) mod P is calculated by previously multiplying x by 2\hat{ }(m+n) mod P or 2\hat{ }(2n) mod P and multiplying the result by 2\hat{ }(−m) or 2\hat{ }(−n) afterward. When Montgomery modular multiplication is used, subsequent process is carried out according to the conventional method. When a general modular multiplication method is used, the result of the modular exponentiation operation is corrected by multiplying the result by (2\hat{ }(−n))\hat{ }(2\hat{ }n−1) mod P.

### BACKGROUND OF THE INVENTION

The present invention relates to an information processing method, and in particular, to a technique employed for a tamper resistant device such as an IC card having high confidentiality.

### DESCRIPTION OF THE RELATED ART

In CRT (Chinese Remainder Theorem) calculation which is used as fast algorithm for RSA cryptosystem, a remainder x mod P is calculated in the first step of the calculation. FIG. 1 is a flow chart showing a processing flow of a CRT calculation method. First, a modular exponentiation operation is done to a value reduced in modulo P (1010) while another modular exponentiation operation is done to a value reduced in modulo Q (1020). Finally, the results of two modular exponentiation operations are combined to obtain the end result (1030). In the first step of each modular exponentiation operation (1010, 1020) with regard to the value reduced in modulo P or Q, the remainder of x modulo P or Q (P, Q: secret exponents) has to be obtained. The modular exponentiation operation can be carried out by repeating modular multiplication.

For the exponentiation calculation in the steps 1010 and 1020, the so-called “addition chain” method is generally used. In an addition chain for calculating Z=\hat{ }L for example, the exponent L is expressed in a binary form as:

L=L[n−1]*2\hat{ }(n−1)+L[n−2]*2\hat{ }(n−2)++L[1]*2\hat{ }1+L[0]*2\hat{ }0 (1)

where the operator “\hat{ }” means power and “*” means multiplication. Using the low of exponent in which the addition in the exponent means multiplication and the multiplication in the exponent means power, the calculation Z=\hat{ }L is expressed as:

Z:=((((A\hat{ }L[n−1])\hat{ }2*(A\hat{ }L[n−2]))\hat{ }2* . . . *(A\hat{ }L[0]) (2)

The value A\hat{ }L[i] equals A when L[i]=1 and 1 when L[i]=0, therefore, omitting the multiplications by 1 (when L[i]=0), Z=A\hat{ } can be calculated by performing several multiplications for the bits 1 in the binary expression of L and performing squaring calculation m−1 times.

The above calculation can be represented by the following program:

Z=1

for (i=n−1; i>=0; i++){

W:=W*W;

if (L[i]==1) then Z:=Z*A; else W:=W*1;

}

Methods for the modular multiplication can be classified into two groups: those employing Montgomery modular multiplication and others.

FIG. 2 is a flow chart showing a processing flow of the modular exponentiation operation by the addition chain when the Montgomery modular multiplication is employed. In FIG. 2, “n” denotes the number of bits enough for storing P. First, the remainder of x modulo P (the remainder of x divided by P) is obtained (2020). Since each multiplication in the Montgomery modular multiplication involves multiplication by 2\hat{ }(−n) mod P, the operand is previously multiplied by 2\hat{ }n (hereafter, R=2\hat{ }n). The operation multiplying the operand by R is also carried out by the Montgomery modular multiplication. The value A=x mod P is multiplied by previously calculated R\hat{ }2 by means of the Montgomery modular multiplication, by which xR mod P is obtained (2040). Since the Montgomery modular multiplication is employed, the initial value of the operation is set not to 1 but to R (1 multiplied by R) (2050). In the multiplication process, each bit of the exponent will be extracted one by one starting from the most significant bit, therefore, a value n−1 indicating the position of the most significant bit is first set to a counter i (2050). Subsequently, whether each bit value of the exponent is 1 or not is checked starting from the highest bit (2060). If the bit value is 0 (NO in the step 2060), the current value W is multiplied by R (which means 1) (2070). Meanwhile, if the bit value is 1 (YES in the step 2060), the current value W is multiplied by A_R=×R mod P (2080). Incidentally, since the step 2070 for multiplying by R (meaning 1) has no effect on the calculation result, it can be omitted when the processing speed is important. Subsequently, the bit position counter i is decremented by 1 (2090) and whether the bit position has reached the least significant bit or not is checked (2100). If the bit position has not reached the least significant bit (YES in the step 2100), the current value is squared (2110) and the process from the step 2060 is repeated for the next bit of the exponent. If the process has already finished for the least significant bit (NO in the step 2100), the current value W is simply multiplied by the factor 2\hat{ }(−n) in order to eliminate the effect of the previous multiplication by 2\hat{ }n. In the Montgomery modular multiplication, obtaining the product of the operand and 1 is equivalent to multiplying the operand by 2\hat{ }(−n) (2120). Finally, when the result is P or more (YES in step 2130), P is subtracted from the result (2140). In the above processing flow, the result of the modular calculation of the step 2020 changes sharply depending on whether x is larger or smaller than a multiple of P (3010) as shown in FIG. 3, therefore, the step or the behavior might be used as an attack point.

FIG. 4 is a flow chart showing a processing flow of the modular exponentiation operation by the addition chain when a modular multiplication method other than the Montgomery modular multiplication is employed. In FIG. 4, the bit length of P is expressed as “n”. First, the remainder of x modulo P is obtained (4020). Similarly to the above example employing the Montgomery modular multiplication, there is a possibility that the calculation of the remainder modulo P might become an attack point. The initial value of the operation is set to 1 since an ordinary modular multiplication method is used, and a value n−1 indicating the position of the most significant bit is first set to a counter i so that each bit of the exponent will be extracted one by one starting from the most significant bit (4040). Subsequently, whether each bit value of the exponent is 1 or not is checked starting from the highest bit (4050). If the bit value is 1 (YES in the step 4050), the current value W is multiplied by A=x mod P (4070). If the bit value is 0 (NO in the step 4050), the current value W is multiplied by 1 (4060). Incidentally, the step 4060 for multiplying by 1, having no effect on the calculation result, can be omitted when the processing speed is important. The step 4070 might also become an attack point since the value of A=x mod P is used for the operand. Subsequently, the bit position is shifted rightward by 1 bit by decrementing the bit position counter i by 1 (4080) and whether the bit position has reached the least significant bit or not is checked (4100). If the bit position has not reached the least significant bit yet (YES in the step 4100), the current value W is squared (4090) and the above process is conducted for the next bit of the exponent. When the process is completed for the least significant bit (NO in the step 4100), the current value W becomes the final result of the operation.

As described above, in either case using or not using the Montgomery modular multiplication, the remainder of x modulo P has to be obtained at the first step of the operation, and thus there is a possibility that the modular calculation might become an attack point.

The RSA cryptosystem is a cryptographic technology generally used for authentication, sending a private key (secret key), etc. as a standard, and the reliability and safety of its calculation method have great importance for financial uses etc. Although a method employing the Chinese Remainder Theorem is widely used today as fast algorithm for the RSA cryptosystem, a modular calculation modulo P (P: secret prime) has to be conducted in the first step of the algorithm. The modular calculation, using the secret prime P explicitly, has been a target of attack from long ago. What becomes a problem in the modular calculation modulo P is that when x is close to a multiple of P (3010) as shown in FIG. 3, x mod P takes on large values (x mod P _P) if x<kP, while taking on small values (x mod P≅0) if x>kP. Due to the rapid change of x mod P across the boundary kP, there is a danger that whether the input x is larger or smaller than the secret exponent P might be detected as side channel information (electric current, etc.). The RSA cryptosystem is regarded as safe based on the fact that the product N of large prime numbers P and Q (approximately 512 bits at present) can not be factorized easily, and the number N as the product of the prime numbers P and Q is disclosed to the user as part of the public key. However, if the secret prime P or Q leaks out, the other secret prime Q=N/P or P=N/Q can be calculated easily and consequently, the private key d can be obtained by calculating the inverse element of the public key e modulo (P−1)(Q−1). The inverse calculation can be carried out easily by extended Euclid's algorithm.

### SUMMARY OF THE INVENTION

It is therefore the primary object of the present invention to provide an information processing method or calculation method capable of carrying out the modular calculation for the CRT (Chinese Remainder Theorem) safely and at high speed.

In an information processing method in accordance with an aspect of the present invention, x mod P is calculated not directly, but x*(2\hat{ }n) mod P is calculated by previously multiplying x by 2\hat{ }(m+n) mod P or 2\hat{ }(2n) mod P and multiplying the result by 2\hat{ }(−m) or 2\hat{ }(−n) afterward. The number P, being a large prime number, is necessarily an odd number and thus is relatively prime with any power of 2. Hence there necessarily exists 2\hat{ }(−m) mod P or 2\hat{ }(−n) mod P. Further, even when the input x is close to P, the value of x*(2\hat{ }n) mod P does not change rapidly depending on whether x is larger or smaller than P, and x*(2\hat{ }n) mod P has a bit length close to that of P. By virtue of the above characteristics, it becomes impossible to estimate whether x is larger or smaller than P based on the leaked information, by which the leakage of the private key can be prevented. In the case where the Montgomery modular multiplication is employed, the 2\hat{ }n-multiplied form of the expression exactly follows the Montgomery field, therefore, the subsequent process can be conducted according to the conventional processing flow.

On the other hand, when the Montgomery modular multiplication is not employed, a correct result can be obtained by compensating for the effect of the multiplication by 2\hat{ }n mod P, by multiplying the result of the exponentiation operation by (2\hat{ }(−n))\hat{ }(2\hat{ }n−1) mod P.

When a modular multiplication method other than the Montgomery modular multiplication is employed, multiplication and squaring are carried out and thereafter the result is multiplied by R\hat{ }(−2) mod P. It is also possible to previously calculate R\hat{ }(−2m) mod P and finally correct the result by multiplying by R\hat{ }(−(2\hat{ }m)+1) mod P.

The objects and features of the present invention will become more apparent from the consideration of the following detailed description taken in conjunction with the accompanying drawings.

### BRIEF DESCRIPTION OF THE DRAWINGS

FIG. 1 is a flow chart showing a processing flow of a typical CRT calculation method for RSA cryptosystem;

FIG. 2 is a flow chart showing a processing flow of a conventional modular exponentiation operation for the CRT calculation method when Montgomery modular multiplication is employed;

FIG. 3 is a graph showing the relationship between the input x and the result of modular calculation x mod P (P: secret prime);

FIG. 4 is a flow chart showing a processing flow of a conventional modular exponentiation operation for the CRT calculation method when a general modular multiplication method is employed;

FIG. 5 is a flow chart showing a secure modular calculation process employing Montgomery modular multiplication in accordance with an embodiment of the present invention;

FIG. 6 is a flow chart showing another secure modular calculation process employing Montgomery modular multiplication in accordance with another embodiment of the present invention;

FIG. 7 is a flow chart showing a part of the secure modular calculation process employing Montgomery modular multiplication;

FIG. 8 is a flow chart showing a secure modular exponentiation process employing Montgomery modular multiplication in accordance with another embodiment of the present invention;

FIG. 9 is a flow chart showing a part of the secure modular exponentiation process;

FIG. 10 is a flow chart showing another part of the secure modular exponentiation process;

FIG. 11 is a flow chart showing another part of the secure modular exponentiation process;

FIG. 12 is a graph showing the bit length and humming weight of x mod P (x: input, P: secret prime) according to a conventional calculation method; and

FIG. 13 is a graph showing the bit length and humming weight of x*2\hat{ }n mod P (x: input, P: secret prime) according to the present invention.

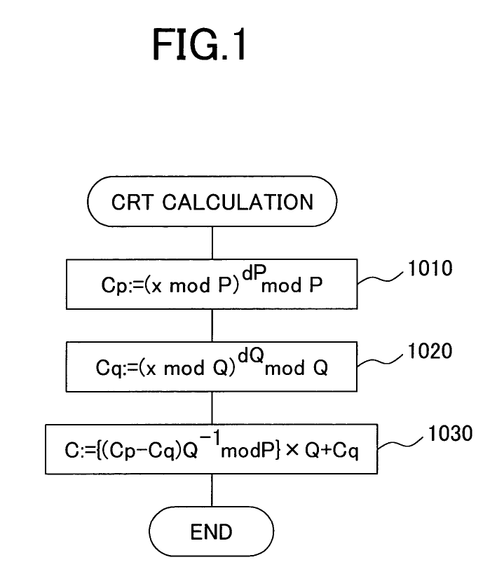

### DESCRIPTION OF THE EMBODIMENTS

Referring now to the drawings, a description will be given in detail of preferred embodiments in accordance with the present invention.

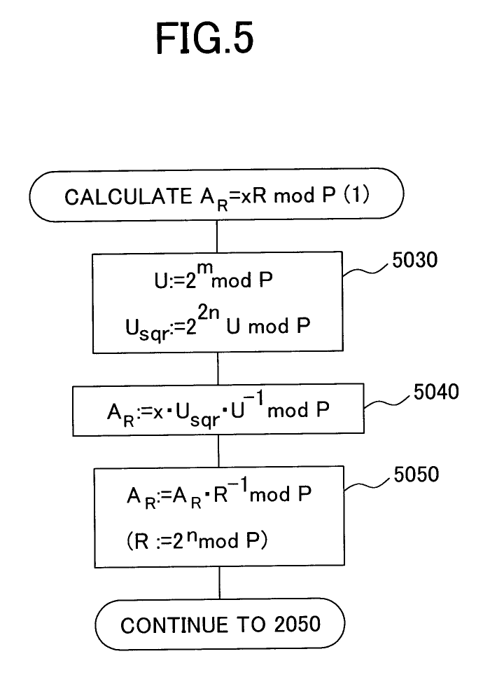

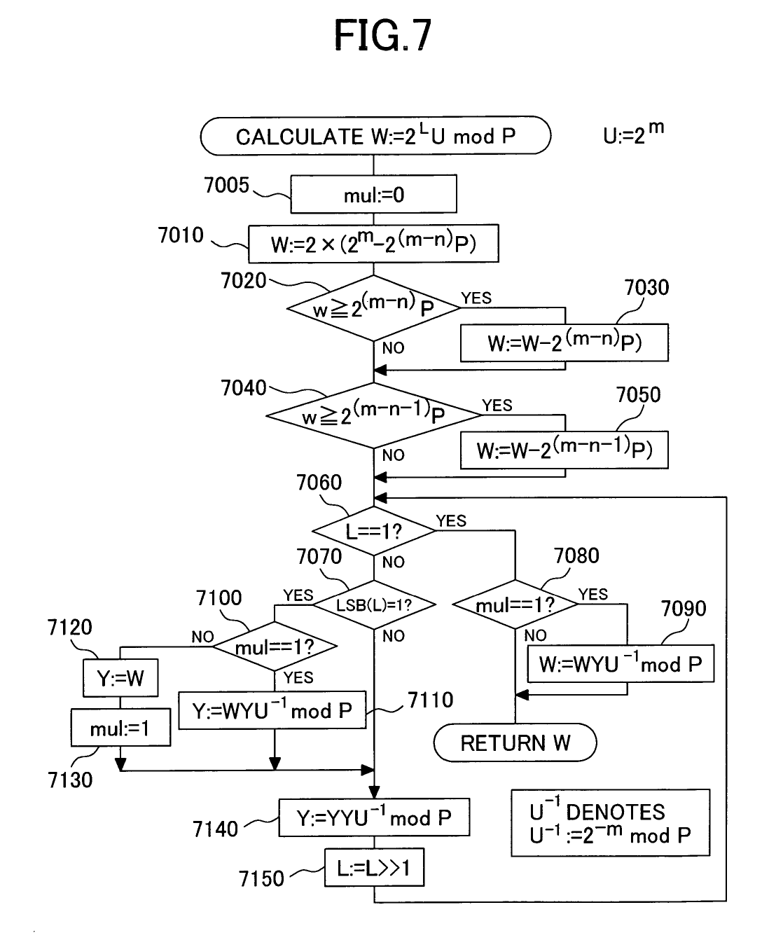

FIG. 5 is a flow chart showing an embodiment of the present invention in which the Montgomery modular multiplication is employed. In FIG. 5, the number “m” denotes a bit length necessary for storing the input x and “n” denotes a bit length necessary for storing P. The number m is necessarily larger than or equal to n (m≧n) since 0<x<P*Q. First, U=2\hat{ }m mod P and U_SQR=2\hat{ }(2n)U mod P are calculated (5030). Incidentally, the above symbol “_” is used in this document to mean subscript. A detailed processing flow for calculating U_SQR=2\hat{ }(2n)U mod P is shown in FIG. 7. While FIG. 7 shows a procedure for calculating 2*U mod P, it can be used directly by substituting 2n into L (L=2n). The bit length of U_SQR equals that of the longer one of m−2n and n. The calculation of the step 5040 can be expressed as:

A_{—}R=(x*U_{—}SQR+M*P)/2\hat{ }m (3)

As x<2\hat{ }m and M<2\hat{ }m hold, the following inequality holds:

A_{—}R<U_{—}SQR+P (4)

As the bit length of P is n or less, the bit length of A_R can be described as MAX (m−2n, n). Letting the bit length of A_R be n or less requires:

m−2n<n (5)

that is:

m<3n (6)

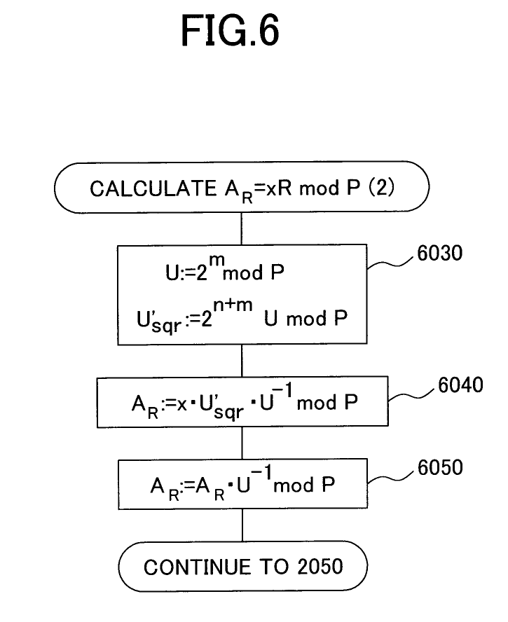

In ordinary cases, m≅2n<3n holds and thus the bit length of A_R equals n. In order to carry out step 5050, the result of the step 5040 is required to be n or less. When the condition m<3n is not satisfied, another method of FIG. 6 in accordance with another embodiment of the present invention is carried out. The process of the step 5050 can be represented by a differently expression as:

(A_{—}R+(−A_{—}R*P\hat{ }(−1) mod 2\hat{ }n)*P)/2\hat{ }n (7)

Since A_R<2\hat{ }n and (−A_R*p\hat{ }(−1) mod 2\hat{ }n)<2\hat{ }n hold, the following inequality is satisfied:

(A_{—}R+(−A_{—}R*P\hat{ }(−1) mod 2\hat{ }n)*P)/2\hat{ }n<1+P (8)

Therefore, A_R after the step 5050 does not exceed P and thus can be expressed by n bits. Incidentally, A_R becomes equal to P in the step 5050 only when x is a multiple of P. The process of the steps 5030 through 5050 can be expressed as follows:

A_{—}R=x*2\hat{ }(2n)*2\hat{ }m*2\hat{ }(m)*2\hat{ }(−n)mod P (9)

=x*2\hat{ }(2n+m−m−n)mod P (10)

=x*2\hat{ }n mod P (11)

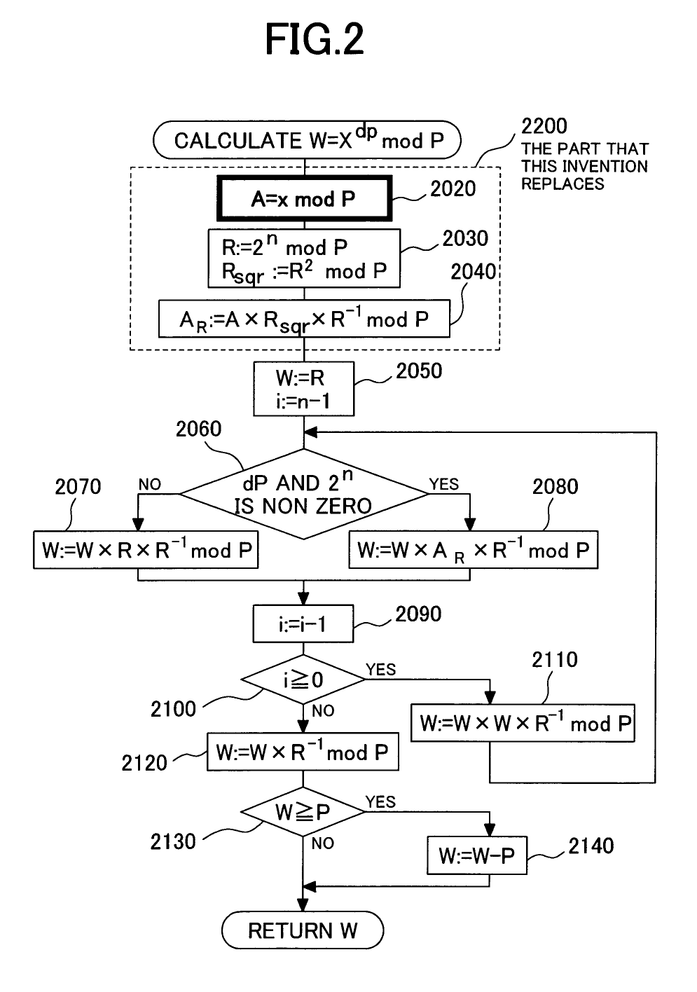

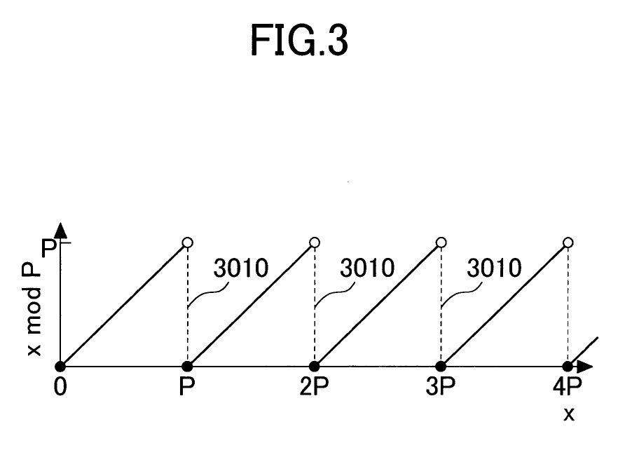

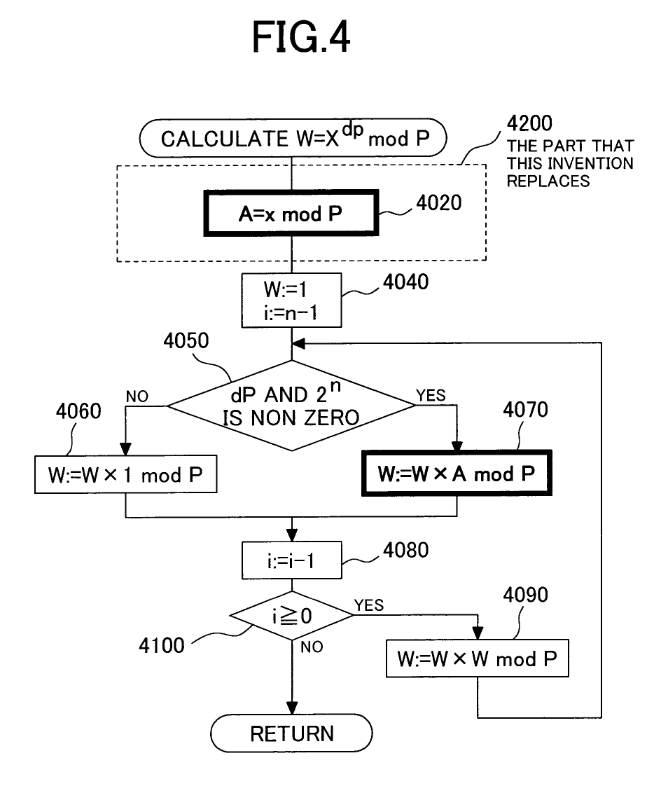

The subsequent process after the step 5050 can be conducted according to the aforementioned process starting from the step 2050 of FIG. 2. In the case where x is a multiple of P, the result is finally corrected in the steps 2130 and 2140 of FIG. 2.

FIG. 6 is a flow chart showing another embodiment of the present invention in which the Montgomery modular multiplication is employed. In FIG. 6, “m” denotes the bit length necessary for storing the input x and “n” denotes the bit length necessary for storing P. The number m is necessarily larger than or equal to n (m≧n) since 0<x<P*Q. First, U′_SQR=2\hat{ }(n+m)U mod P is calculated according to the flow of FIG. 7 by letting L=n+m (6030). In order to conduct the process from step 6040, the number of bits of U′_SQR is required to be m or less, and the condition is always satisfied. The process of the step 6050 can be expressed as:

(A_{—}R+(−A_{—}R*P\hat{ }(−1) mod 2\hat{ }m)*P)/2\hat{ }m) (12)

Since A_R<2\hat{ }n and (−A_R*P\hat{ }(−1) mod 2\hat{ }m)<2\hat{ }m hold, the following inequality is satisfied:

(A_{—}R+(−A_{—}R*P\hat{ }(−1) mod 2\hat{ }m)*P)/2\hat{ }m)<1+P (13)

Therefore, A_R after the step 6050 becomes P or less and can be expressed by n bits or less. Incidentally, A_R becomes equal to P in the step 6050 only when x is a multiple of P. The process of the steps 6030 through 6050 can be represented by one expression as:

A_{—}R=x*2\hat{ }(n+m)*2\hat{ }m*2\hat{ }(−m)*2\hat{ }(−m)mod P* (14)

x*2\hat{ }(n+m+m−m−m)mod P (15)

=x*2\hat{ }n mod P (16)

The subsequent process after the step 6050 can be conducted according to the aforementioned process starting from the step 2050 of FIG. 2. In the case where x is a multiple of P, the result is finally corrected in the steps 2130 and 2140 of FIG. 2. Differently from the previous embodiment of FIG. 5, the condition m<3n is not required in this embodiment.

FIG. 7 is a flow chart showing a procedure for calculating 2\hat{ }L*U mod P which is necessary for the embodiments of FIGS. 5 and 6. The flow of FIG. 7 calculates W:=2\hat{ }L*R mod P by means of the addition chain starting from the least significant bit. The initial value of W is set to w≡2*(2\hat{ }m) mod P so as to be accommodated in m bits. The calculation can be done only by conducting modular squaring operation L times if the binary expression of L except the most significant bit includes no 1, whereas extra multiplication becomes necessary on the way if there is a bit 1 in the binary expression of L except the most significant bit. Therefore, a variable “mul”, indicating whether a bit 1 has been found in the bits of L other than the most significant bit or not, is prepared (7005). Step 7010 lets W be accommodated in m bits, by subtracting a number obtained by shifting P until the most significant bit of P comes to the most significant bit of m bits. Steps 7020, 7030, 7040 and 7050 sets the most significant two bits of W to “00”, which are conducted in order to let the final calculation result be accommodated in n bits. Subsequently, whether the process has reached the most significant bit or not is checked (7060). If the process has reached the most significant bit (YES in the step 7060), whether the variable mul is 1 or not is checked (7080). If the variable mul is 1 (YES in the step 7080), calculation result corresponding to intermediate bits of L has already been stored in a variable Y, therefore, W is multiplied by Y (7090) to give the final result. If the process has not reached the most significant bit yet (NO in the step 7060), whether the least significant bit of L is 1 or not is checked (7070). If the least significant bit of L is 1 (YES in the step 7070), the value of W is stored in the variable Y. Whether the variable mul is 1 or not is checked in step 7100, and if a bit 1 is found for the first time in the bits of L other than the most significant bit (NO in the step 7100), the value of W is substituted into Y (7120) and the variable mul is set to 1 (7130). The process in the step 7120 is equivalent to first substituting 1 into Y and thereafter executing Y:=Y*W. Meanwhile, if a bit 1 has already been found in the bits of L other than the most significant bit (YES in the step 7100), Y is multiplied by the current value of W (7110). Subsequently, modular squaring is carried out to R by Montgomery modular multiplication (7140) and L is shifted rightward by 1 bit (7150). Thereafter, the process from the step 7060 is repeated.

The calculation of Y*Y*2\hat{ }(−m) mod P of the step 7140 is equivalent to:

(A*A+M*P)/(2\hat{ }m) (17)

where:

M=−Y*Y*(P\hat{ }(−1))mod 2\hat{ }m<2\hat{ }m (18)

Therefore, the following inequality holds:

(Y*Y+M*P)/(2\hat{ }m)<(Y*Y+2\hat{ }m*P)/(2\hat{ }m) (19)

Meanwhile, if we define “s” as the number of most significant bits 0 when Y is stored in m-bit memory, the following inequalities hold:

Y<2\hat{ }(m−s) (20)

Y<=2\hat{ }(m−s)−1 (21)

(Y*Y+2\hat{ }m*P)/(2\hat{ }m)<=((2\hat{ }(m−s)−1)\hat{ }2+2m*P)/2\hat{ }m (22)

=2\hat{ }(m−2s)−2\hat{ }(1−s)+2\hat{ }(−m)+P (23)

<2\hat{ }(m−2s)+P+1 (24)

Hence the number s of the most significant bits 0 of the calculation result (Y*Y+M*P)/2\hat{ }m in the step 7140 changes as s[t+1]:=2s[t]−1 each time (Y*Y+M*P)/2\hat{ }m is calculated. Thus, when 2\hat{ }(m−2s) is larger than P, the number of the consecutive most significant bits 0 becomes s[0]*2\hat{ }(t−1) after t time calculations. On the other hand, when 2\hat{ }(m−2s) has become smaller than P, the bit length is determined by P. Since the most significant two bits of W are set to “00” in the steps 7020, 7030, 7040 and 7050 (s[0]=2), the bit length after executing the step 7140 t times becomes m−2\hat{ }t or n. The bit length equals max(m−L, n) since t=log2(L).

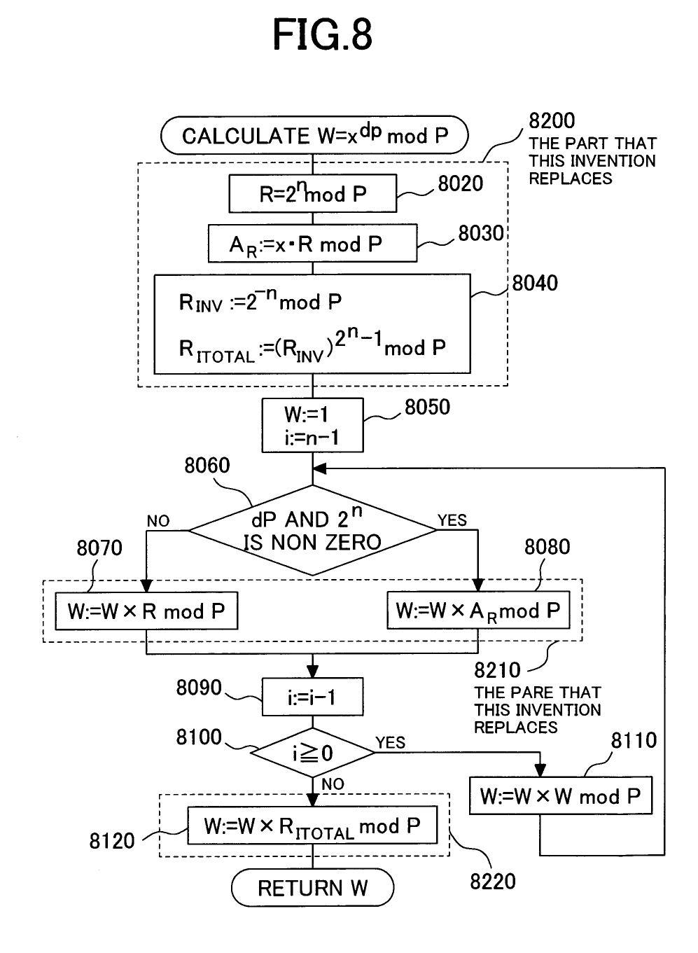

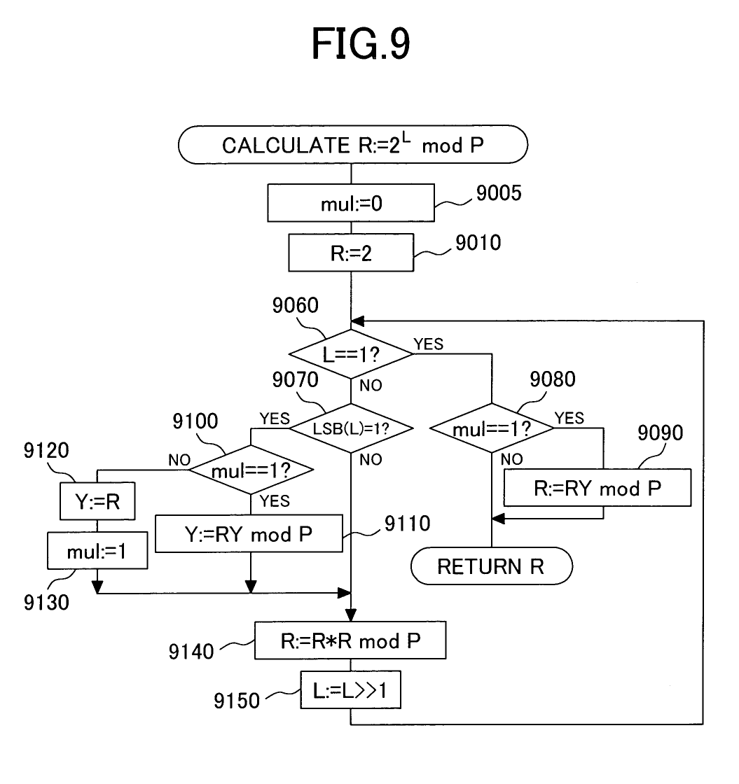

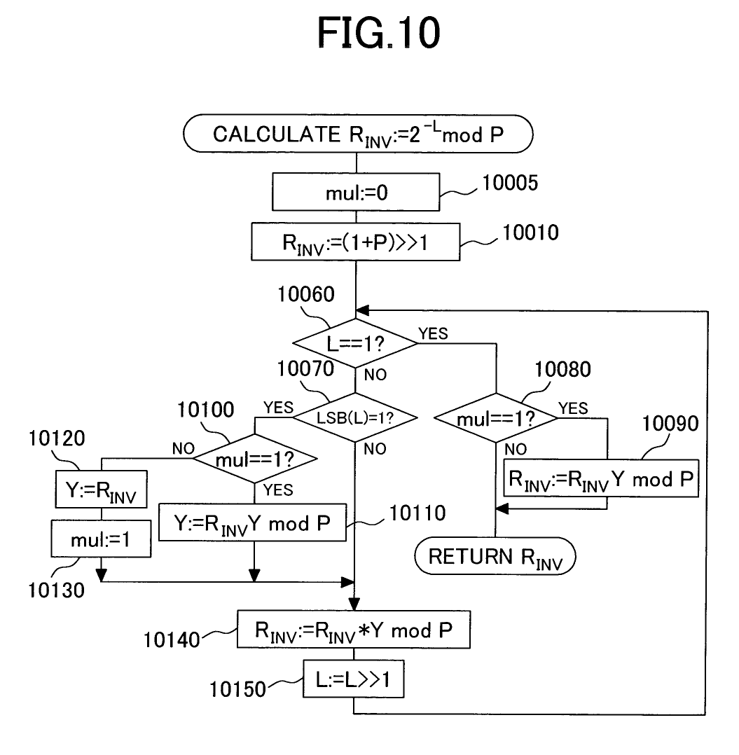

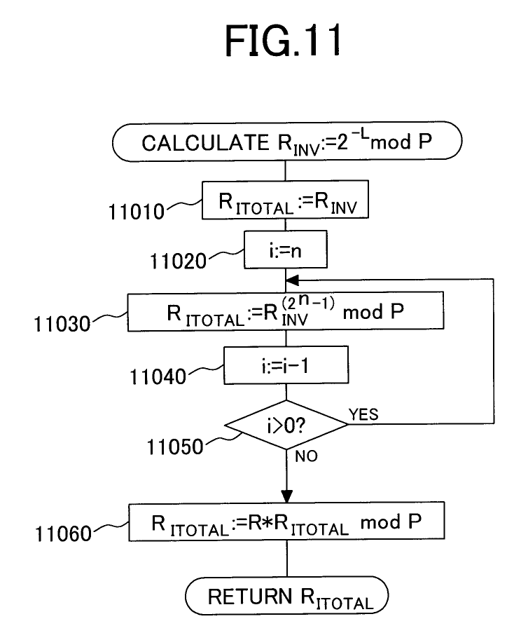

FIG. 8 is a flow chart showing an embodiment of the present invention in which an ordinary modular multiplication method is employed. In FIG. 8, “m” denotes a bit length necessary for storing the input x and “n” denotes a bit length necessary for storing P. First, 2\hat{ }n mod P is calculated according to the flow of FIG. 9 and the result is substituted into R (8020). Subsequently, the input x is multiplied by R (8030) and a value R_ITOTAL to be used for final correction is calculated (8040). When P is a definite and fixed value, R_ITOTAL can be calculated independently of the input x and thus it is possible to previously calculate and prestore R_ITOTAL. In actual calculation, R_INV=2\hat{ }(−n) mod P is first calculated according to the flow of FIG. 10, and R_ITOTAL=(R_INV)\hat{ }(2\hat{ }n−1) mod P is calculated based on R and R_INV according to the flow of FIG. 11. Subsequently, the initial value W of the operation is set to 1 since an ordinary modular multiplication method is used, and a value n−1 indicating the position of the most significant bit is first set to a counter i (8050). Subsequently, whether each bit value is 1 or not is checked starting from the highest bit of the exponent (8060). If the bit value is 1 (YES in the step 8060), the current value W is multiplied by A_R=xR mod P (8080). If the bit value is 0 (NO in the step 8060), the current value W is multiplied by R (meaning 1) (8070). Subsequently, the bit position is shifted rightward by 1 bit by decrementing the bit position counter i by 1 (8090) and whether the process has been completed for the least significant bit or not is checked (8100). If the process has not reached the least significant bit yet (YES in the step 8100), the current value W is squared (8110) and the above process is conducted for the next bit of the exponent. Since the process of the steps 8070 and 8080 includes the extra multiplication by R every time in comparison with the conventional process, the result has been multiplied by extra R\hat{ }(2\hat{ }n−1) at the point when the process is completed for the least significant bit. Hence the result is finally multiplied by R_ITOTAL (8120) in order to eliminate the effect of the extra multiplication by R\hat{ }(2\hat{ }n−1).

FIG. 9 is a flow chart showing a procedure for calculating 2\hat{ }L mod P in the step 8020 of the embodiment of FIG. 8. The flow of FIG. 9 calculates R:=2\hat{ }L mod P by means of the addition chain starting from the least significant bit. The calculation can be done only by conducting modular squaring operation L times if the binary expression of L except the most significant bit includes no 1, whereas extra multiplication becomes necessary on the way if there is a bit 1 in the binary expression of L except the most significant bit. A variable “mul”, indicating whether a bit 1 has been found in the bits of L other than the most significant bit or not, is prepared and initialized to 0 (9005), and the value R is initialized to 2 (9010). Subsequently, whether the process has reached the most significant bit or not is checked (9060). If the process has already reached the most significant bit (YES in the step 9060), whether the variable mul is 1 or not is checked (9080). If mul=1 (YES in the step 9080), calculation result corresponding to intermediate bits of L has already been stored in a variable Y, therefore, R is multiplied by Y (9090) to give the final result. If the process has not reached the most significant bit yet (NO in the step 9060), whether the least significant bit of L is 1 or not is checked (9070). If the least significant bit of L is 1 (YES in the step 9070), the storing in the variable Y is conducted. Whether the variable mul is 1 or not is checked in step 9100, and if a bit 1 is found for the first time in the bits of L other than the most significant bit (NO in the step 9100), the value of R is substituted into Y (9120) and the variable mul is set to 1 (9130). The process in the step 9120 is equivalent to first substituting 1 into Y and thereafter executing Y:=Y*R. Meanwhile, if a bit 1 has already been found in the bits of L other than the most significant bit (YES in the step 9100), Y is multiplied by the current value of R (9110). Subsequently, modular squaring is carried out to R (9140) and L is shifted rightward by 1 bit (9150). Thereafter, the process from the step 9060 is repeated.

FIG. 10 is a flow chart showing a procedure for calculating R_INV:=2\hat{ }(−n) mod P in the step 8040 of the embodiment of FIG. 8. The flow of FIG. 10 calculates R_INV:=2\hat{ }(−L) mod P by means of the addition chain starting from the least significant bit. The calculation can be done only by conducting modular squaring operation L times if the binary expression of L except the most significant bit includes no 1, whereas extra multiplication becomes necessary on the way if there is a bit 1 in the binary expression of L except the most significant bit. A variable “mul”, indicating whether a bit 1 has been found in the bits of L other than the most significant bit or not, is prepared and initialized to 0 (10005), and the value R_INV is initialized to ½. The initialization to ½ can be done by shifting 1 rightward once. Since mere right shift of 1 gives 0, the right shift is conducted after adding P. The value P, being a large prime number, is necessarily an odd number, hence 1+P is necessarily an even number and can be shifted rightward. Subsequently, whether the process has reached the most significant bit or not is checked (10060). If the process has already reached the most significant bit (YES in the step 10060), whether the variable mul is 1 or not is checked (10080). If mul 1 (YES in the step 10080), calculation result corresponding to intermediate bits of L has already been stored in a variable Y, therefore, R_INV is multiplied by Y (10090) to give the final result. If the process has not reached the most significant bit yet (NO in the step 10060), whether the least significant bit of L is 1 or not is checked (10070). If the least significant bit of L is 1 (YES in the step 10070), the storing in the variable Y is conducted. Whether the variable mul is 1 or not is checked in step 10100, and if a bit 1 is found for the first time in the bits of L other than the most significant bit (NO in the step 10100), the value of R_INV is substituted into Y (10120) and the variable mul is set to 1 (10130). The process in the step 10120 is equivalent to first substituting 1 into Y and thereafter executing Y:=Y*R. Meanwhile, if a bit 1 has already been found in the bits of L other than the most significant bit (YES in the step 10100), Y is multiplied by the current value of R (10110). Subsequently, modular multiplication of R and Y is conducted (10140) and L is shifted rightward by 1 bit (10150). Thereafter, the process from the step 10060 is repeated.

FIG. 11 is a flow chart showing a procedure for calculating R_ITOTAL:=(R_INV)\hat{ }(2\hat{ }n−1) mod P in the step 8040 of the embodiment of FIG. 8. The calculation is carried out by multiplying R_INV\hat{ }(2\hat{ }n) by R as shown in the following equation (26). The multiplicand R_INV\hat{ }(2\hat{ }n) is calculated by repeating modular squaring operation n times.

(R_{—}INV)\hat{ }(2\hat{ }n−1)mod P=R_{—}INV\hat{ }(2\hat{ }n)*R_{—}INV\hat{ }(−1)mod P (25)

=R_{—}INV\hat{ }(2\hat{ }n)*R mod P (26)

First, R_ITOTAL is initialized to R_INV (11010) and a number “n”, indicating the number of times of modular squaring operation to be repeated, is substituted into a variable i as a counter (11020). In each modular squaring operation, the result of modular squaring of R_ITOTAL is substituted into R_ITOTAL (11030) and the counter variable i is decremented by 1 (11040). Subsequently, the counter variable i is checked (11050), and if the counter variable i is larger than 0 (YES in the step 11050), the process from the step 11030 is repeated. When the counter variable i reached 0 (NO in the step 11050), the current value R_ITOTAL is finally multiplied by R by means of modular multiplication and the obtained value is substituted into R_ITOTAL (11060) to be returned as the final result.

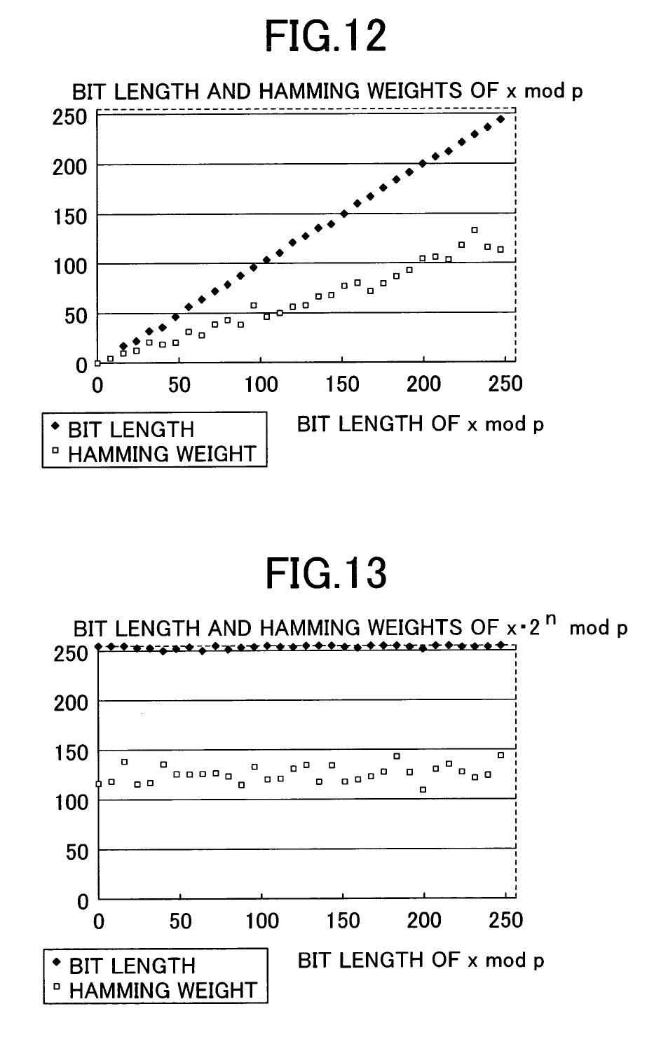

As set forth hereinabove, by the present invention, the CRT calculation employing the modular exponentiation operation can be carried out without the need of directly obtaining the remainder (x mod P) of the input value x divided by the secret prime P. Therefore, it becomes difficult to estimate the secret prime P by conventional attacking methods such as measuring electric current etc. while changing the input x. FIG. 12 shows the bit length and humming weight (the number of bits 1 in binary expression) of x mod P in the case where a conventional calculation method is employed, while FIG. 13 shows the bit length and humming weight of x*2\hat{ }n mod P (which corresponds to x mod P) in the present invention. An apparent dependency relationship is seen in FIG. 12 between input data and x mod P, whereas the bit length and humming weight are almost constant independently of input data and such dependency can not be seen in FIG. 13.

Other aspects of the present invention are as follows:

1. A processing method for conducting a calculation modulo N, wherein:

an operand of the calculation is previously multiplied by a value V obtained as a power of a number relatively prime with the modulus N, and

the result of the above calculation is multiplied by an inverse element of the value V modulo N.

2. A processing method for conducting a modular calculation modulo N, wherein:

an operand of the modular calculation is previously multiplied by a value V obtained as a power of a number relatively prime with the modulus N, and

the result of the calculation is multiplied by an inverse element of the value V modulo N, and

the modulus N equals the product of prime numbers that are larger than 2, and

the number relatively prime with the modulus N equals 2.

3. An information processing device comprising a Montgomery modular multiplication device, for calculating x*(2\hat{ }n) mod P for an input value x larger than a prime number P, wherein:

the value x*(2\hat{ }n) mod P is calculated without explicitly obtaining x mod P, by:

calculating or previously preparing 2\hat{ }(2m+n) mod P when the input value x has to be transformed into x*(2\hat{ }n) mod P, the number n denoting the number of bits necessary and sufficient for storing the modulus P and the number m denoting the number of bits necessary for storing the input value x;

calculating x1=x*2\hat{ }(2m+n)*(2\hat{ }(−m)) mod P=x*2\hat{ }(m+n) mod P by the Montgomery modular multiplication device; and

calculating x2:=x1*(2\hat{ }(−m)) mod P=x*(2\hat{ }n) mod P.

4. An information processing method for calculating x*(2\hat{ }n) mod P for an input value x larger than a prime number P, wherein:

the value x*(2\hat{ }n) mod P is calculated without explicitly obtaining x mod P, by:

calculating or previously preparing 2\hat{ }(2 m+n) mod P when the input value x has to be transformed into x*(2\hat{ }n) mod P, the number n denoting the number of bits necessary and sufficient for storing the modulus P and the number m denoting the number of bits necessary for storing the input value x;

calculating x1=x*2\hat{ }(2 m+n)*(2\hat{ }(−m)) mod P=x*2\hat{ }(m+n) mod P by Montgomery modular multiplication; and

calculating x2:=x1*(2\hat{ }(−m)) mod P=x*(2\hat{ }n) mod P.

5. An information processing device comprising a Montgomery modular multiplication device, for calculating x*(2\hat{ }n) mod P for an input value x larger than a prime number P, wherein:

the value x*(2\hat{ }n) mod P is calculated without explicitly obtaining x mod P, by:

calculating or previously preparing 2\hat{ }(m+2n) mod P when the input value x has to be transformed into x*(2\hat{ }n) mod P, the number n denoting the number of bits necessary and sufficient for storing the modulus P and the number m denoting the number of bits necessary for storing the input value x;

calculating x1=x*2\hat{ }(m+2n)*(2\hat{ }(−m)) mod P=x*2\hat{ }(2n) mod P by the Montgomery modular multiplication device; and

calculating x2:=x1*(2\hat{ }(−n)) mod P=x*(2\hat{ }n) mod P.

6. An information processing method for calculating x*(2\hat{ }n) mod P for an input value x larger than a prime number P, wherein:

the value x*(2\hat{ }n) mod P is calculated without explicitly obtaining x mod P, by:

calculating or previously preparing 2\hat{ }(m+2n) mod P when the input value x has to be transformed into x*(2\hat{ }n) mod P, the number n denoting the number of bits necessary and sufficient for storing the modulus P and the number m denoting the number of bits necessary for storing the input value x;

calculating x1=x*2\hat{ }(m+2n)*(2\hat{ }(−m)) mod P=x*2\hat{ }(2n) mod P by Montgomery modular multiplication; and

calculating x2:=x1*(2\hat{ }(−n)) mod P=x*(2\hat{ }n) mod P.

7. An information processing device for conducting a modular exponentiation operation x\hat{ }d mod P for an input value x and an exponent d, by combining results of exponentiation operations each of which is carried out for each s-bit segment successively extracted from the exponent d, wherein:

the value x\hat{ }d mod P is calculated not by calculating x\hat{ }d[i] mod P, the exponent d[i] denoting i-th segment of the extracted s-bit segment of the exponent d, but by:

calculating (2\hat{ }n)\hat{ }(2\hat{ }n−1)*x\hat{ }d mod P by use of (2\hat{ }n)\hat{ }(2\hat{ }s−1)*x\hat{ }d[i] mod P, the number n denoting the number of bits necessary and sufficient for storing the modulus P and the number m denoting the number of bits necessary for storing the input value x; and

calculating the value x\hat{ }d mod P by multiplying the above result (2\hat{ }n)\hat{ }(2\hat{ }n−1)*x\hat{ }d mod P by 2\hat{ }(−n)\hat{ }(2\hat{ }n−1) mod P.

8. An information processing method for conducting a modular exponentiation operation x\hat{ }d mod P for an input value x and an exponent d, by combining results of exponentiation operations each of which is carried out for each s-bit segment successively extracted from the exponent d, wherein:

the value x\hat{ }d mod P is calculated not by calculating x\hat{ }d [i] mod P, the exponent d[i] denoting i-th segment of the extracted s-bit segment of the exponent d, but by:

calculating (2\hat{ }n)\hat{ }(2\hat{ }n−1)*x\hat{ }d mod P by use of (2\hat{ }n)\hat{ }(2\hat{ }s−1)*x\hat{ }d[i] mod P, the number n denoting the number of bits necessary and sufficient for storing the modulus P and the number m denoting the number of bits necessary for storing the input value x; and

calculating the value x\hat{ }d mod P by multiplying the above result (2\hat{ }n)\hat{ }(2\hat{ }n−1)*x\hat{ }d mod P by 2\hat{ }(−n)\hat{ }(2\hat{ }n−1) mod P.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An information processing method for calculating x*(2\hat{ }n) mod P for an input value x larger than a prime number P, the operator \hat{ } denoting power, wherein:
the value x*(2\hat{ }n) mod P is calculated without explicitly obtaining x mod P, by:
calculating or previously preparing 2\hat{ }(2 m+n) mod P when the input value x has to be transformed into x*(2\hat{ }n) mod P, the number n denoting the number of bits necessary and sufficient for storing the modulus P and the number m denoting the number of bits necessary for storing the input value x;
calculating x1=x*2\hat{ }(2 m+n)*(2\hat{ }(−m)) mod P=x*2\hat{ }(m+n) mod P by Montgomery modular multiplication; and
calculating x2:=x1*(2\hat{ }(−m)) mod P=x*(2\hat{ }n) mod P.

2. An information processing method for calculating x*(2\hat{ }n) mod P for an input value x larger than a prime number P, the operator \hat{ } denoting power, wherein:
the value x*(2\hat{ }n) mod P is calculated without explicitly obtaining x mod P, by:
calculating or previously preparing 2\hat{ }(m+2n) mod P when the input value x has to be transformed into x*(2\hat{ }n) mod P, the number n denoting the number of bits necessary and sufficient for storing the modulus P and the number m denoting the number of bits necessary for storing the input value x;
calculating x1=x*2\hat{ }(m+2n)*(2\hat{ }(−m)) mod P=x*2\hat{ }(2n) mod P by Montgomery modular multiplication; and
calculating x2:=x1*(2\hat{ }(−n)) mod P=x*(2\hat{ }n) mod P.

3. An information processing method for conducting a modular exponentiation operation x\hat{ }d mod P for an input value x and an exponent d, by combining results of exponentiation operations each of which is carried out for each s-bit segment successively extracted from the exponent d, wherein:
the value x\hat{ }d mod P is calculated not by calculating x\hat{ }d [i] mod P, the exponent d[i] denoting i-th segment of the extracted s-bit segment of the exponent d, but by:
calculating (2\hat{ }n)\hat{ }(2\hat{ }n−1)*x\hat{ }d mod P by use of (2\hat{ }n)\hat{ }(2\hat{ }s−1)*x\hat{ }d[i] mod P, the number n denoting the number of bits necessary and sufficient for storing the modulus P and the number m denoting the number of bits necessary for storing the input value x; and
calculating the value x\hat{ }d mod P by multiplying the above result (2\hat{ }n)\hat{ }(2\hat{ }n−1)*x\hat{ }d mod P by 2\hat{ }(−n)\hat{ }(2\hat{ }n−1) mod P.
